(19) United States
(12) Patent Application Publication
(10) Pub. No.: US 2012/0318204 A1
(43) Pub. Date: Dec. 20, 2012

(54) ANIMAL SYSTEM TOILET AND LIQUID PERMEABLE PANEL USED THEREWITH

(75) Inventors: Takayuki Matsuo, Kagawa (JP); Tomoko Hirao, Kagawa (JP)

(73) Assignee: UNI-CHARM CORPORATION, Ehime (JP)

(21) Appl. No.: 13/519,091

(22) PCT Filed: Oct. 4, 2010
(86) PCT No.: PCT/JP2010/005941

§ 371 Date: Sep. 11, 2012

(30) Foreign Application Priority Data
Dec. 28, 2009 (JP) 2009-298783

(51) Int. Cl. A01K 29/00

(52) U.S. Cl. 119/166

(57) ABSTRACT

An animal system toilet that allows for easy cleaning while almost completely eliminating wet feet due to urine during excretion and contamination of a room due to the wet feet, and a disposable liquid permeable panel for an animal system toilet is provided that allows for easy cleaning of the animal system toilet and that can remarkably prevent wet feet during excretion using the animal system toilet and contamination of a room caused by the wet feet. An animal system toilet is used that includes: an excrement storage unit; a liquid permeable panel that is disposed above the excrement storage unit and passes liquid through; and a supporting unit that supports the liquid permeable panel while forming a space between the excrement storage unit and the liquid permeable panel, in which the liquid permeable panel has water absorbency and is configured to be detachable with respect to the supporting portion.

### TECHNICAL FIELD

The present invention relates to an animal system toilet and a liquid permeable panel used therewith.

### BACKGROUND ART

Conventionally, an animal toilet that can be installed indoors has been used for disposal of excrement of an animal kept indoors. In recent years, as such an animal toilet, an animal toilet on which commercially available absorbent pet sheet is directly laid on a floor thereof, an animal toilet in which an absorbent pet sheet is fixed by an outer frame for holding an outer periphery of the pet sheet, an animal toilet in which a plate-like urine absorbent mat and a liquid permeable nonwoven fabric that closely covers a whole area of an upper face of the urine absorbent mat are housed in a shallow tray-like pan and the like have been used.

However, with these animal toilets, since an animal excretes in a state of standing directly on the pet sheet or the nonwoven fabric, a problem of the animal stepping on excrement and a problem of excrement spreading on the pet sheet or on the nonwoven fabric immediately after excretion, leading to the animal's feet becoming wet due to contact with urine, may occur frequently. In a case where a pet with such wet feet moves around a room after excretion, the floor of the room will be contaminated with urine. Accordingly, an animal toilet that does not cause a problem of the animal's feet becoming wet has been strongly demanded.

In order to address the problem of wet feet due to urine in the animal toilets in which an animal excretes in a state of standing directly on the pet sheet or the nonwoven fabric, an animal toilet has been proposed in which a hygroscopic material such as a pet sheet or cat litter is placed in a rectangular pan and a lattice-shaped frame is disposed with an appropriate amount of space from the hygroscopic material.

However, even with the animal toilet as such, a small amount of urine adhering to the lattice-shaped frame still causes wet feet, and further improvement is required regarding the occurrence of wet feet.

In addition, in the animal toilet as described above, since an opening of the lattice-shaped frame is configured to be moderately small in area as an animal excretes on the lattice-shaped frame, feces that are excreted tend to easily clog the opening of the lattice-shaped frame. Therefore, the animal toilet as described above has another problem in that it is necessary to frequently perform cumbersome cleaning of the lattice-shaped frame.

Furthermore, an animal such as a dog, cat or the like that excretes indoors is trained to excrete in the same area of a room. However, even though a dog, cat or the like tries to excrete in the same area, it rarely excretes repeatedly at a position on an absorbent sheet such as a pet sheet where previous excrement has been absorbed. For example, if an animal once excretes and excrement is absorbed in a central portion of the pet sheet, the animal tends to avoid the central portion for the next excretion and excretes in the periphery thereof. This is because dogs and cats tend to dislike a wet sensation, i.e. coldness due to moisture adhered to paws, and generally instinctively do not like to be wet. Considering such a habit, it is desired that a portion thereof that paws of the animal directly contact remains as dry as possible.

### SUMMARY OF INVENTION

Given this, the present invention provides an animal system toilet that allows for easy cleaning while almost completely eliminating wet feet due to urine during excretion and contamination of a room due to the wet feet. In addition, the present invention provides a disposable liquid permeable panel for an animal system toilet that allows for easy cleaning of the animal system toilet and that can remarkably suppress wet feet during excretion using the animal system toilet and contamination of a room cause by the wet feet.

During the course of the present invention, the present inventors have conducted extensive research. As a result, the inventors have developed an animal system toilet including: an excrement storage unit; a liquid permeable panel that is disposed above the excrement storage unit and passes liquid through; and a supporting unit that supports the liquid permeable panel while forming a space between the excrement storage unit and the liquid permeable panel, in which the liquid permeable panel has water absorbency and is configured to be detachable with respect to the supporting portion, thereby arriving at completion of the present invention. More specifically, the invention provides the following.

An animal system toilet includes: an excrement container including an excrement storage unit; and a liquid permeable panel that is disposable having water absorbency and that is removably disposed so as to cover an upper space of the excrement storage unit.

A disposable liquid permeable panel for an animal system toilet, wherein the liquid permeable panel has water absorbency, and liquid permeability thereof in a thickness direction is at least 90%

### BRIEF DESCRIPTION OF DRAWINGS

FIG. 1 is a perspective view of an animal system toilet according to a first embodiment;

FIG. 2 is a perspective view of the animal system toilet according to the first embodiment, in a state where a liquid permeable panel and a drawer tray are detached;

FIG. 3 is a schematic view of a cross-section of the animal system toilet according to the first embodiment;

FIG. 4 is a top view of a liquid permeable panel used with the animal system toilet according to the first embodiment;

FIG. 5 is a cross-sectional view of a liquid permeable panel used with the animal system toilet according to the first embodiment;

FIG. 6 is a perspective view of an animal system toilet according to a second embodiment;

FIG. 7A is a top view of an animal system toilet according to a third embodiment;

FIG. 7B is a sectional view taken along a line I-I of the sanitary napkin shown in FIG. 7A;

FIG. 8A is a top view of an animal system toilet according to a fourth embodiment;

FIG. 8B is a sectional view taken along a line II-II of the sanitary napkin shown in FIG. 8A;

FIG. 8C is a sectional view taken along a line of the sanitary napkin shown in FIG. 8A;

FIG. 9A is a top view of an animal system toilet according to a fifth embodiment;

FIG. 9B is a sectional view taken along a line IV-IV of the sanitary napkin shown in FIG. 9A; and

FIG. 9C is a sectional view taken along a line V-V of the sanitary napkin shown in FIG. 9A.

### DESCRIPTION OF EMBODIMENTS

Embodiments of the present invention are described hereinafter with reference to the drawings. It should be noted that the embodiments of the present invention are not limited by the following examples and the technical scope of the present invention is not limited thereto. In this specification, “animal” refers to animals kept in doors, such as dogs and cats.

### 1. First Embodiment

### Overall Structure

First, an overall structure of the animal system toilet 1 of the present invention is described referring to the animal system toilet 1, which is the first embodiment of the present invention.

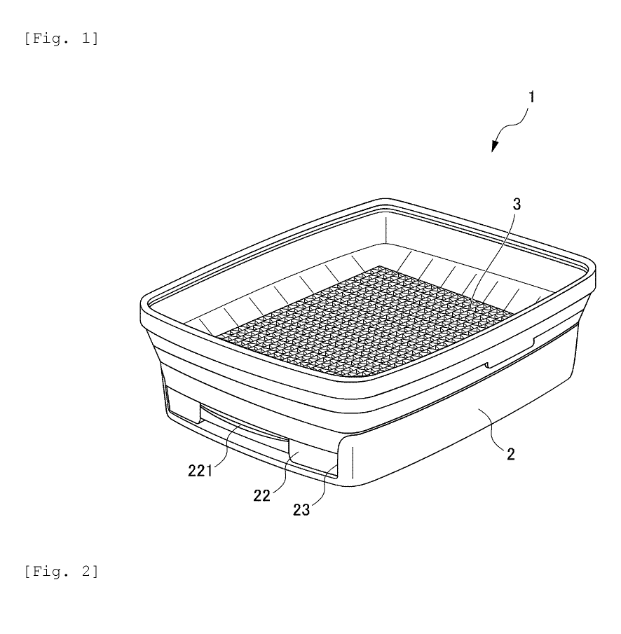

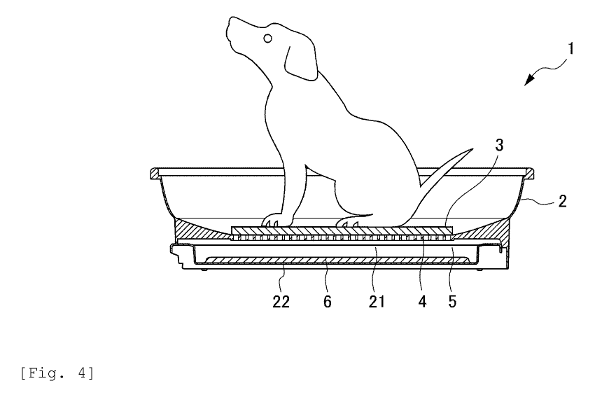

The animal system toilet 1 according to the first embodiment is described with reference to FIGS. 1, 2, and 3. As shown in FIG. 3, the animal system toilet 1 includes: an excrement container 2 including an excrement storage unit 21 having a space 5 for storing the excrement thereinside; a disposable liquid permeable panel 3 that is disposed above the excrement storage unit 21 to cover an upper space and passes liquid through; and a supporting unit 4 that supports the liquid permeable panel 3 while forming the space 5 between the excrement storage unit 21 and the liquid permeable panel 3. In addition, the liquid permeable panel 3 is composed of panel materials that have water absorbency and is configured to be detachable with respect to the supporting portion 4. Furthermore, as shown in FIG. 3, the space 5 is formed between the supporting portion 4 and the excrement storage unit 21.

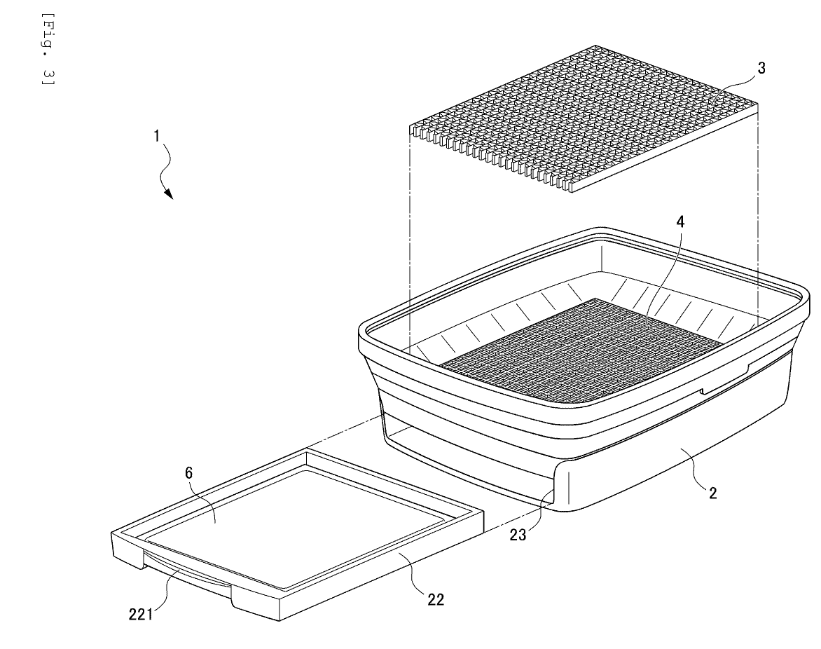

As shown in FIG. 2, in the first embodiment, the supporting unit 4 is composed of a lattice-shaped porous plate and supports substantially the whole area of a lower face of the liquid permeable panel 3. A shape of each opening in the lattice-shaped porous plate is not particularly limited as long as the shape does not prevent the object of the present invention, and is typically a rectangular shape of 1 to 100 mm, and more preferably 3 to 50 mm, in length in vertical and horizontal directions. In addition, a thickness of a bar of the lattice-shaped porous plate in vertical and horizontal directions is 1 to 10 mm. A thickness of the supporting unit 4 is not particularly limited as long as the supporting unit 4 can support the liquid permeable panel 3 and bear the weight of an animal, and is typically 1 to 10 mm. Specific embodiments of the supporting unit 4 will be described later in other embodiments.

The material for the lattice-shaped porous plate is not particularly limited as long as the lattice-shaped porous plate can support the liquid permeable panel 3 and pass excrement to the excrement storage unit 21, and can be various materials such as wood, metal, plastic and the like. Among these materials, plastic is preferably used due to not having a problem of generating odor due to excrement penetrating the material, and a problem of corrosion by excrement, and for favorably passing excrement to the excrement storage unit 21. As the plastic, various materials such as polyethylene, polypropylene, polyvinyl chloride resin, polystyrene, ABS resin, AS resin, polyester resin (polyethylene terephthalate and the like), polyamide resin, polycarbonate resin and the like can be used.

In the excrement container 2, a wall surface is formed vertically upward and downward from a periphery of the supporting unit 4. In other words, the supporting unit 4 extends from the inner periphery of the excrement container 2, at substantially a middle portion in the thickness direction of the excrement container 2. Excrement can be directly stored in the excrement storage unit 21 inside the excrement container 2; or an excrement absorbent article 6 that can absorb excrement can be preferably placed in the excrement storage unit 21. A specific example of the excrement absorbent article 6 includes a pet sheet, pet litter and the like, which can be appropriately selected from conventionally known products. A specific example of the pet litter may include bentonite, paper, zeolite, silica gel or the like that is formed into a substantially spherical shape of a few millimeters to a few centimeters in diameter.

A drawer tray 22 that can be pulled out in a horizontal direction may be preferably provided in a bottom portion of the excrement container 2, and the excrement storage unit 21 inside the excrement container 2 is preferably provided in the drawer tray 22. The drawer tray 22 can store excrement by itself or can be used in a state where the excrement absorbent article 6 is placed thereinside. By providing the drawer tray 22, the excrement storage unit 21 can be cleaned very easily. In addition, the drawer tray 22 may be preferably provided with a handle 221 for easy detachment from the excrement container 2. The shape of the handle 221 is not particularly limited as long as a user can grip the drawer tray 22.

The shape of an opening in an upper portion of the excrement container 2 is not particularly limited and can be selected from various shapes such as a square, rectangle, trapezoid, oval, circle, semicircle and the like, considering the design and the like. The shape of an opening in an upper portion of the excrement container 2 is preferably a square or rectangle, since an excess member is not generated when cutting out the liquid permeable panel 3 from a large absorbent panel.

### Disposable Liquid Permeable Panel

Next, the disposable liquid permeable panel 3 of the present invention is described. The liquid permeable panel 3 is in a flat panel shape as a whole, and is configured to be detachable with respect to the supporting unit 4 and to cover substantially the whole area of the opening of the excrement container 2, as shown in FIGS. 1 and 2.

The thickness of the liquid permeable panel 3 varies depending on the configuration, material and the like of the panel; however, typically the thickness is preferably 3 to 25 mm, more preferably 3 to 10 mm, and most preferably 3 to 7 mm as measured with a ruler. If the liquid permeable panel 3 is too thin, a problem of strength may easily arise; for example, deformation of the panel may prevent permeation of excrement to the excrement storage unit 21 and the panel may break depending on the weight of the animal. If the liquid permeable panel 3 is too thick, there is a problem in that the duration of use may be shorten due to an increased amount of absorbed excrement per excretion in the liquid permeable panel 3 and a problem in that the panels for replacement become bulky when stored.

A liquid permeable panel 3 having a plurality of holes that penetrates therethrough in a thickness direction and passes excrement through the plurality of holes in the thickness direction of the liquid permeable panel 3 is preferably used. The plurality of holes may have either the same or a different shape and area. Such a liquid permeable panel 3 having the plurality of holes can reduce the amount of excrement remaining in the disposable liquid permeable panel 3 more easily and can prevent wet feet of an animal that steps on the liquid permeable panel 3 more easily, compared to, for example, a panel having holes in irregular directions such as a sponge-like material.

In a case where the liquid permeable panel 3 has a plurality of holes that penetrates therethrough in a thickness direction of the liquid permeable panel 3, an average area of an opening of the plurality of holes is preferably 10 to 100 mm² per hole, and more preferably 15 to 60 mm² per hole. The average area is measured by means of analyzing and calculating the areas of openings in image processing. If the average area of an opening of the plurality of holes that is too small, it is not preferable since an amount of excrement adhered to the disposable liquid permeable panel 3 increases and it is difficult to suppress wet feet. On the other hand, if the average area of an opening of the plurality of holes that is too great, it is not preferable since the disposable liquid permeable panel 3 must be made thick for sufficient strength of the liquid permeable panel 3. A measuring method of the average area of an opening of the plurality of holes is not particularly limited and various conventionally known methods can be used, for example, a method of analyzing an image of the opening.

In a case where the liquid permeable panel 3 has the plurality of holes that penetrates therethrough in a thickness direction thereof, a preferable structure of the panel is a honeycomb structure or a corrugated honeycomb structure, for example. Among these, a panel of the corrugated honeycomb structure is more preferable for easy of manufacturing and availability at low price.

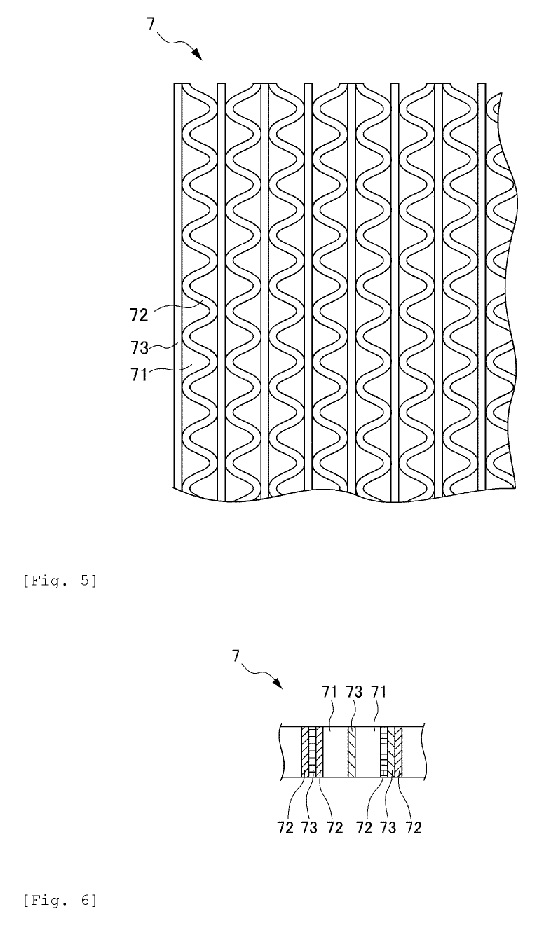

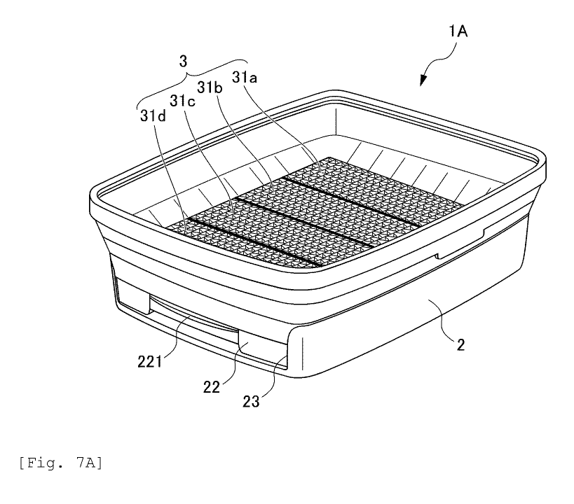

A panel 7 of the corrugated honeycomb structure is hereinafter described with reference to FIGS. 4 and 5. The panel 7 of the corrugated honeycomb structure is composed by joining a corrugated sheet 72 and a flat sheet 73, thereby composing a hole 71 surrounded by the corrugated sheet 72 and the flat sheet 73. The method of joining the corrugated sheet 72 and the flat sheet 73 is not particularly limited and can be appropriately selected from conventionally known methods such as a method of joining by an adhesive and the like. In FIG. 4, the corrugated sheet 72 is constituted of a curved sheet; however, the corrugated sheet 72 can also be constituted of a sheet folded in a zig-zag manner.

The material for a panel having water absorbency that constitutes the liquid permeable panel 3 is not particularly limited as long as the material desirably passes excrement through and has predetermined water absorbency, and various materials can be used. A specific example of the material having water absorbency includes wood fiber such as pulp, various organic or inorganic porous materials such as silica gel and zeolite, and woven or nonwoven fabric constituted of various organic or inorganic fiber materials. A specific example of the organic fiber material includes: a cellulosic fiber material such as wood fiber (e.g., pulp), cotton, linen and the like; an animal fiber such as animal hair (e.g., wool); and a synthetic fiber such as a polyolefin fiber (e.g., polyethylene, polypropylene), a polyester fiber (e.g., polyethylene terephthalate), a nylon fiber (e.g., nylon 6, nylon 66), an acrylic fiber, and the like.

Among these materials, pulp is preferable for easy of processing and low cost, and cardboard that has appropriate liquid permeability and water absorbency is more preferable. In such a case, the cardboard preferably includes a hydrophobizing agent or a water repellent agent such as a sizing agent, such that predetermined water absorbency can be selected by a type and an amount of the sizing agent.

### Liquid Permeability and Water Absorbency of Liquid Permeable Panel

The liquid permeability of the liquid permeable panel 3 is preferably at least 90%, and more preferably at least 93%. By using a disposable liquid permeable panel 3 having such liquid permeability, urine adhered to the liquid permeable panel 3 after excretion can be reduced and dispersion of urine thereinside and wet feet of an animal due to stepping thereon can be easily prevented. The liquid permeability of the liquid permeable panel 3 can be measured by the following method.

### Liquid Permeability Measuring Method

A pan of which the weight (A) is measured in advance is placed below a sample of which the liquid permeability is to be measured, such as the liquid permeable panel 3. Approximately 30 ml of artificial urine is prepared and the weight thereof (B) is measured. A cylinder of 60 mm in internal diameter is placed on the sample and the artificial urine is evenly dropped inside the cylinder, using a syringe having a diameter of 2 mm at a rate of 3 ml/second. At the time when the artificial urine no longer drips off from the sample, the weight (C) of the pan containing the artificial urine is measured. A value of liquid permeability is obtained by the following equation. It is noted that the artificial urine is of a composition described later in the Example.

### Equation for Liquid Permeability

Liquid Permeability(%)=(Weight(C)−Weight(A))/Weight(B)×100 Formula 1

The liquid permeable panel 3 has water absorbency of 10 to 50%/min, and more preferably 15 to 40%/min. By using the liquid permeable panel 3 having such water absorbency, a small amount of excrement adhered thereto after most of the excrement has run through can be absorbed by the liquid permeable panel 3, thereby preventing wet feet. If the water absorbency of the liquid permeable panel 3 is too high, a great amount of excrement will be absorbed by the liquid permeable panel 3 while the excrement permeates therethrough, and wet feet may easily occur due to seeping excrement caused by an animal stepping on a site of excretion. On the other hand, if the water absorbency of the liquid permeable panel 3 is too low, excrement will remain in liquid form on a surface of the liquid permeable panel 3, and wet feet may easily occur. The water absorbency of the liquid permeable panel 3 can be measured by the following method.

### Water Absorbency Measurement Method

The weight (A) of a sample obtained by cutting a measurement target such as the liquid permeable panel 3 to be 5 cm by 5 cm is measured. The sample thus cut is submerged in 200 ml of artificial urine in a 248-ml container for 1 minute. After 1 minute of submerging, the sample is drawn from the artificial urine, the artificial urine adhered to a surface is wiped off, and then the weight (B) of each sample is measured. The value of the water absorbency is obtained by the following equation. It is noted that the same artificial urine as in the measurement of liquid permeability is used.

### Equation for Water Absorbency

Water absorbency(%/min)=(Weight(B)−Weight(A))/Weight(A)×100 Formula 2

By thus configuring the animal system toilet 1, most of the excrement can be passed through the liquid permeable panel 3 to the excrement storage unit 21; while a small amount of excrement adhered to the liquid permeable panel 3 can be absorbed, thereby greatly suppressing wet feet due to excrement. In addition, as described in the background art, it is demanded that a portion of a liquid permeable panel that paws of an animal directly contact remains dry. According to the present invention, excrement can be almost completely passed through the liquid permeable panel and excrement remaining on the liquid permeable panel is almost completely absorbed, therefore, paws of an animal can be kept dry, allowing repeated excretion on the same site. It should be noted that, the liquid permeable panel 3, which is configured to be detachable with respect to the supporting unit 4, can be easily exchanged in the case of contamination due to absorption of urine and clogging with feces, thereby allowing for easy cleaning of the animal system toilet 1.

In addition, the space 5 is formed between the supporting portion 4 and the excrement storage unit 21. As a result, even in a case where a large amount of urine is excreted, the urine permeates through the holes of the liquid permeable panel 3 and is dispersed on a surface on a back face side, and then is absorbed by the excrement absorbent article 6. In other words, the space 5 effectively prevents the urine from flowing back, overflowing the holes, and remaining on a front face side of the liquid permeable panel 3. This suppresses the occurrence of wet feet.

### 2. Second Embodiment

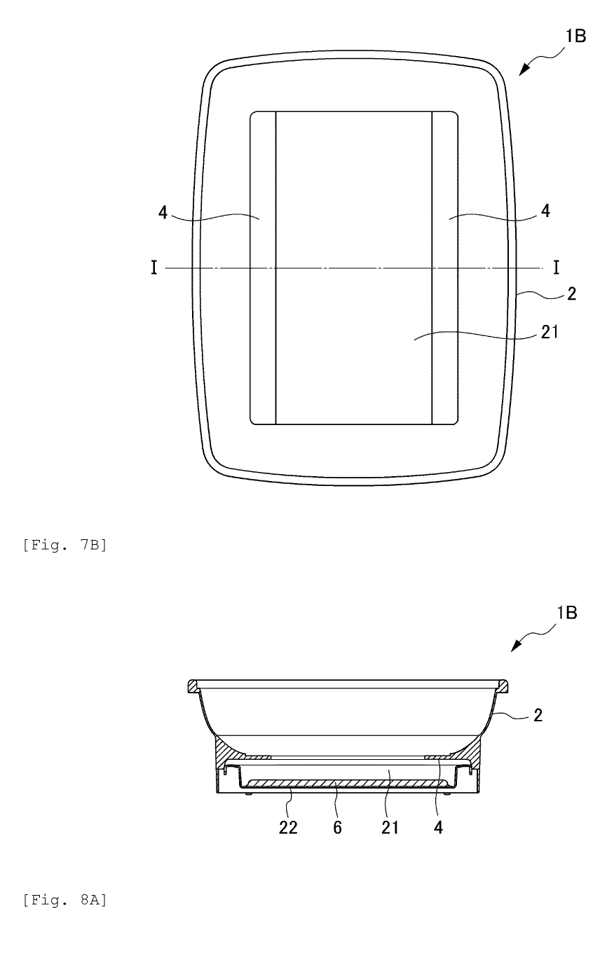

The animal system toilet 1A according to a second embodiment is described with reference to FIG. 6. The second embodiment is different from the first embodiment in that the disposable liquid permeable panel 3 is constituted of a plurality of liquid permeable panel segment bodies 31a, 31b, 31c, and 31d, and the plurality of liquid permeable panel segment bodies 31a, 31b, 31c, and 31d are supported by the supporting unit (not shown) in a state of being aligned along a planar direction.

As shown in FIG. 6, the liquid permeable panel segment bodies 31 are disposed on the supporting unit (not shown) in a state of being aligned along a planar direction. Although the liquid permeable panel 3 is constituted of four liquid permeable panel segment bodies 31 in FIG. 6, the number of the liquid permeable panel segment bodies 31 constituting the liquid permeable panel 3 is not particularly limited and typically is 2 to 10, and more preferably 2 to 8. If the number of the liquid permeable panel segment bodies 31 is too high, placement of the liquid permeable panel segment bodies 31 on the supporting unit 4 along the planar direction becomes cumbersome. By configuring the liquid permeable panel 3 with the liquid permeable panel segment bodies 31 in a state of being aligned along the planar direction, only the liquid permeable panel segment body 31 at a site where an animal frequently excretes can be exchanged and waste can be reduced.

### 3. Third Embodiment

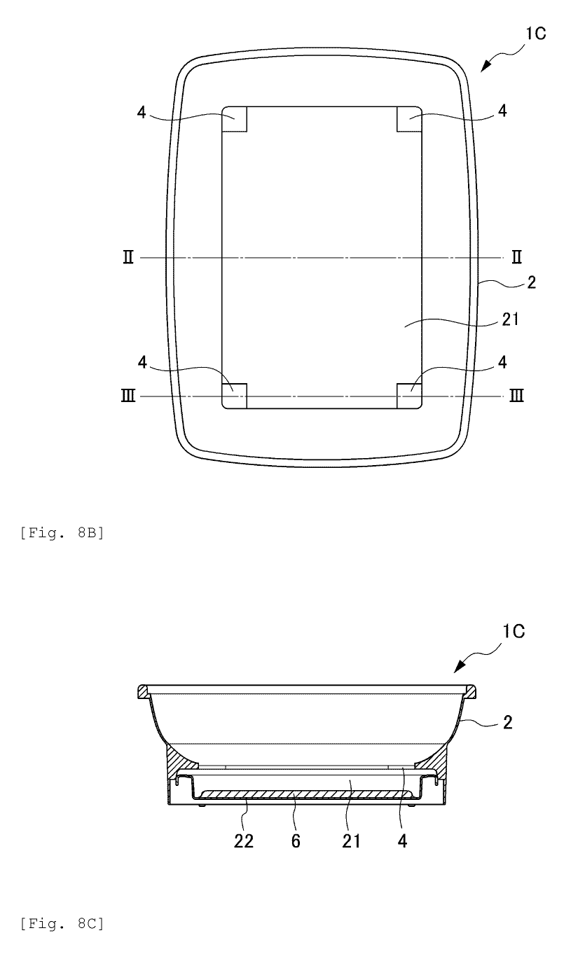

The animal system toilet 1B according to a third embodiment is described with reference to FIGS. 7A and 7B. The third embodiment is different from the first embodiment in that the supporting unit 4 is provided so as to support a lower face of a pair of side portions of the disposable liquid permeable panel (not shown). The supporting unit 4 extends from inner sides of the excrement container 2, and is disposed along a longitudinal direction of the excrement container 2.

As shown in FIGS. 7A and 7B, since the supporting unit 4 is a small member that only supports an entirety (or a part) of a lower face of a pair of side portions of the disposable liquid permeable panel (not shown), cleaning of the supporting unit 4 from an opening in an upper portion of the excrement container 2 becomes easier. In addition, since the supporting unit 4 does not easily become wet with excrement, the frequency of cleaning of the supporting unit 4 is reduced.

### 4. Fourth Embodiment

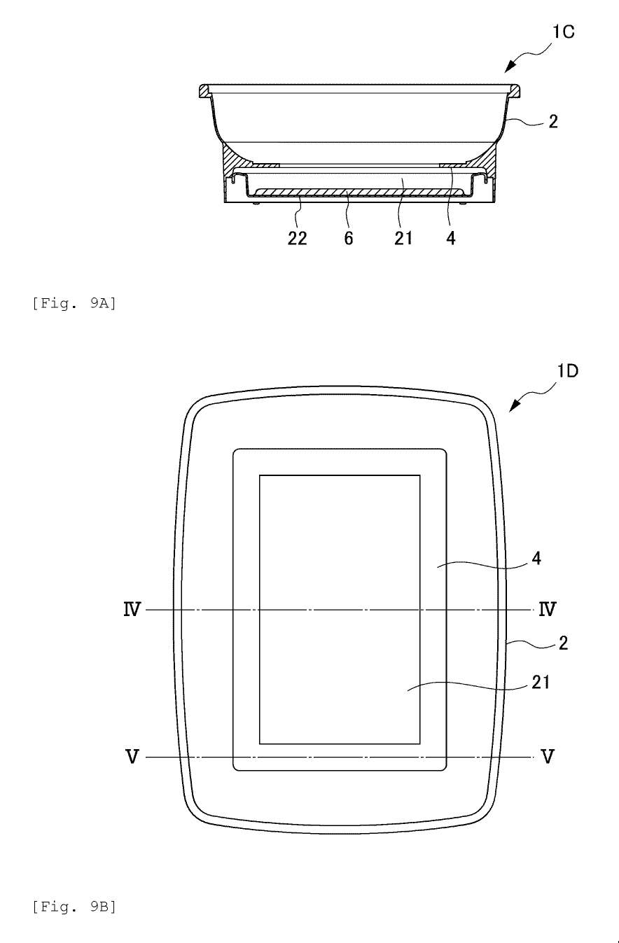

The animal system toilet 1C according to a fourth embodiment is described with reference to FIG. 8A to 8C. The fourth embodiment is different from the first embodiment in that the supporting unit 4 is provided at four sites so as to support four corners of the liquid permeable panel (not shown).

As shown in FIG. 8A to 8C, since the liquid permeable panel (not shown) is supported by the supporting unit 4 at the four corners, the liquid permeable panel (not shown) is stably supported as in the animal system toilet according to the third embodiment. In addition, since the supporting unit 4 is a small member that only supports a part of a lower face of a side portion of the disposable liquid permeable panel (not shown), cleaning of the supporting unit 4 from an opening in an upper portion of the excrement container 2 becomes easier. Furthermore, since the supporting unit 4 does not easily become wet with excrement, the frequency of cleaning of the supporting unit 4 is reduced.

### 5. Fifth Embodiment

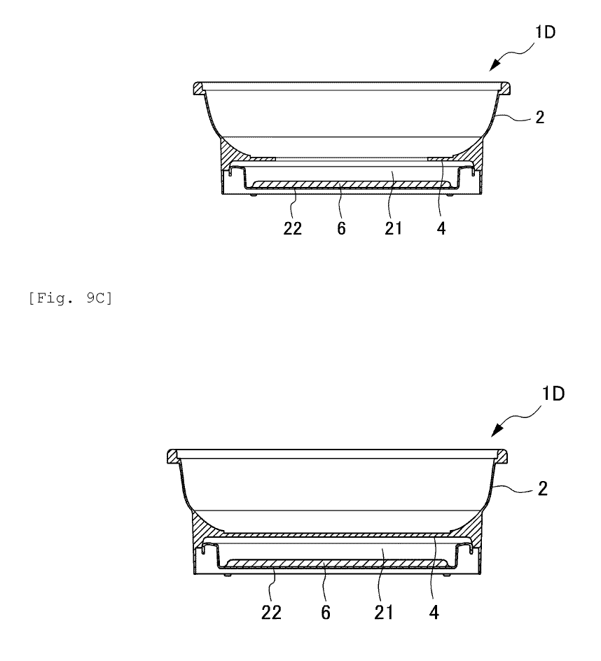

The animal system toilet 1D according to a fifth embodiment is described with reference to FIG. 9A to 9C. The fifth embodiment is different from the first embodiment in that the supporting unit 4 is provided in a rectangular shape along an inner periphery of the excrement container 2 so as to support a lower face of an entire outer periphery of the liquid permeable panel (not shown).

As shown in FIG. 9A to 9C, since the entire lower face of the outer periphery of the liquid permeable panel (not shown) is supported by the supporting unit 4 in the rectangular shape, the liquid permeable panel (not shown) is supported more stably than in the animal system toilet according to the third or fourth embodiment. In addition, since the supporting unit 4 is a member that only supports a periphery of a lower face of the disposable liquid permeable panel (not shown), cleaning of the supporting unit 4 from an opening in an upper portion of the excrement container 2 becomes easier. In addition, since the supporting unit 4 does not easily become wet with excrement, the frequency of cleaning of the supporting unit 4 is reduced. It should be noted that the configuration of the supporting unit of the present invention is only required to have liquid permeability, and is not limited to the above embodiments. For example, the supporting unit can be a member provided with a periphery supporting portion that supports a lower face of a periphery of a liquid permeable layer and a center supporting portion that supports a lower face of a central portion in a predetermined direction and a lower face of a central portion in a direction orthogonal to the predetermined direction of the liquid permeable layer.

The animal system toilet 1 of the present invention is not limited to the above embodiments and can be appropriately changed without departing from the spirit of the present invention. For example, the animal system toilet 1 according to the first to sixth embodiments can be provided with a hood of a desired shape above the excrement container 2, in order to avoid contamination in the vicinity of the animal system toilet 1 due to spatter of urine on the surface of the liquid permeable panel 3.

In addition, in the animal system toilet 1 according to the first embodiment, the supporting unit 4 can be a punching plate having regularly provided round openings, a porous plate having a large number of parallel slits, a net-like plate, or the like, in place of the lattice-shaped porous plate.

The animal system toilet 1 of the present invention can be used as a toilet for an animal kept as a pet such as a dog, cat, rabbit and the like, and can be particularly preferably used as a toilet for a dog kept indoors.

### EXAMPLES

The present invention is described more in detail hereinafter based on Examples; however, the present invention is not limited to these Examples.

Artificial urine of the following composition was used in Reference Example, Examples, and Comparative Examples.

### Composition of Artificial Urine

400 g of urea

160 g of sodium chloride

16 g of magnesium sulfate (heptahydrate)

6 g of calcium chloride (dihydrate)

These substances were adjusted with water to give 20 L of solution. The solution thus adjusted was colored by adding 2 g of Brilliant Blue FCF.

### REFERENCE EXAMPLE

An experiment re-creating contamination of a room due to wet feet after excretion of urine on a plastic grating was performed according to the following method.

### Wet Feet Experimental Method

The following plastic grating was used. Plastic grating: mesh tray (made of polypropylene, with openings of 6 mm by 6 mm and bars of 3.5 mm in vertical and horizontal direction)

A cylinder of 60 mm in internal diameter was placed on the grating and 30 ml of the artificial urine was evenly dropped inside the cylinder. Thirty minutes after dropping, a urethane hemisphere with a diameter of 18 mm was pressed against droplets remaining on the grating, and then stamped on a filter paper (second grade specified by JIS P 3801). As the urethane hemisphere, “soft cushion CN-005” with a diameter of 17.6 mm, height of 9.6 mm, manufactured by WAKI SANGYO CO., LTD. 10-32, Minamikozaka, Higashiosaka-shi, Osaka, Japan, is used. Subsequently, the greatest diameter of a trace of the artificial urine on the filter paper was measured. The same experiment was performed five times at each of three sites (A to C) on the grating. The results of measurement of wet feet contamination are shown in Table 1.

TABLE 1

| | | |
|---|---|---|
| | Number of | Diameter of Trace of |
| Test Site | Applications | Artificial Urine |

| | | | |
|---|---|---|---|
| A | 1 | 8 | mm |
| | 2 | 9 | mm |
| | 3 | 13 | mm |
| | 4 | 12 | mm |
| | 5 | 12 | mm |
| B | 1 | 7 | mm |
| | 2 | 10 | mm |
| | 3 | 13 | mm |
| | 4 | 10 | mm |
| | 5 | 10 | mm |
| C | 1 | 11.5 | mm |
| | 2 | 15 | mm |
| | 3 | 15 | mm |
| | 4 | 16 | mm |
| | 5 | 10 | mm |
| Average | | 11.43 | mm |

By the experiment on Reference Example, in a case where an animal excretes on a plastic grating, assuming that an amount of urine per excretion is 30 ml, a contaminated diameter trace of approximately 11.43 mm was formed on the floor. As a result, it was proved that, with a conventional animal toilet, contamination of the room was caused by wet feet due to urine.

### Examples 1 and 2, Comparative Example 1

The following paper material for the liquid permeable panel, nonwoven fabric material for the liquid permeable panel, and plastic grating were subjected to a wet feet experiment, water absorbency experiment, and a liquid permeability experiment 5 times each, according to the method described below. The results of the liquid permeability experiment are shown in Table 2, the results of the water absorbency experiment are shown in Table 3, and the results of the wet feet experiment are shown in Table 4.

### Material for Liquid Permeable Panel

Paper material for the liquid permeable panel (Example 1): cardboard of A flute, processed to a corrugated honeycomb structure, prepared with NEW RENCOAT as a base paper, 16 mm²/hole in average area of an opening portion of holes. Specifically, the NEW RENCOAT is a paper having a basis weight 180 g/m², manufactured by RENGO CO., LTD., 2-2-7 Nakanoshima, Kita-ku, Osaka-shi, Osaka, Japan. Nonwoven fabric material for the liquid permeable panel (Example 2): cardboard of A flute, processed to a corrugated honeycomb structure, prepared with deodorizing paper of polyester fiber containing activated carbon as a base paper, 10.5 mm²/hole in average area of an opening portion of holes, with 4.8% of paraffinic water repellent agent. As the base paper, “Dasshu-honeycomb DC121” manufactured by AZUMI FILTER PAPER CO., LTD, 4-2-15 Komatsu, Yodogawa-ku, Osaka-shi, Osaka, Japan is used. Plastic grating (Comparative Example 1): mesh tray (made of polypropylene, with openings of 6 mm by 6 mm and bars of 3.5 mm in vertical and horizontal direction)

### Liquid Permeability Experiment

A pan of which weight (A) is measured in advance was placed below a sample of which liquid permeability was to be measured. Approximately 30 ml of artificial urine was prepared and the weight thereof (B) was measured. A cylinder of 60 mm in internal diameter was placed on the sample and the artificial urine was evenly dropped inside the cylinder. At the time when the artificial urine no longer dripped off from the sample, the weight (C) of the pan containing the artificial urine was measured. The value of liquid permeability was obtained by the following equation.

### Equation for Liquid Permeability

Liquid Permeability(%)=(Weight(C)−Weight(A))/Weight(B)×100 Formula 3

Water absorbency Experiment

The weight (A) of a sample obtained by cutting the material for the disposable liquid permeable panel 3 to be 5 cm by 5 cm is measured. The sample thus cut was soaked in artificial urine for 1 minute. After 1 minute of soaking, the sample is drawn from the artificial urine, the artificial urine adhered to a surface is wiped off, and then weight (B) of each sample is measured. The value of the water absorbency is obtained by the following equation.

Equation for Water absorbency

Water Absorbency(%/min)=(Weight(B)−Weight(A))/Weight(A)×100 Formula 4

### Wet Feet Experiment

A cylinder of 60 mm in internal diameter was placed on the material of the disposable liquid permeable panel 3 and 30 ml of the artificial urine was evenly dropped inside the cylinder. After dropping, the cylinder was removed and the material was left for 30 minutes. The weight (A) of filter paper (second grade specified by JIS P 3801) of 10 cm by 10 cm was measured. Thirty minutes after dropping, the filter paper of 10 cm by 10 cm was placed on a site at which the artificial urine was dropped on the material of the liquid permeable panel 3, and left to rest for 5 seconds. After 5 seconds, the weight (B) of the filter paper was measured. The result of the wet feet experiment was obtained by the following equation.

### Equation for Wet Feet

Wet Feet(g)=Weight(B)−Weight(A)

TABLE 2
Results of Liquid Permeability Test

| | | Example 2 | Comparative |
|---|---|---|---|
| | Example 1 | Nonwoven | Example 1 |
| | Paper Liquid | Fabric Liquid | Plastic |
| | Permeable Panel | Permeable Panel | Grating |
| 1st | 95.3% | 90.8% | 96.6% |
| Application | | | |
| 2nd | 95.9% | 93.1% | 99.6% |
| Application | | | |
| 3rd | 95.2% | 93.2% | 96.0% |
| Application | | | |
| 4th | 95.2% | 93.8% | 96.1% |
| Application | | | |
| 5th | 93.0% | 93.2% | 95.7% |
| Application | | | |
| Average | 94.9% | 92.8% | 96.8% |

TABLE 3
Results of Water Absorbing Property Test

| | | Example 2 | Comparative |
|---|---|---|---|
| | Example 1 | Nonwoven | Example 1 |
| | Paper Liquid | Fabric Liquid | Plastic |
| | Permeable Panel | Permeable Panel | Grating |
| 1st | 39.7%/min | 29.2%/min | 0.0%/min |
| Application | | | |
| 2nd | 24.2%/min | 36.0%/min | 0.0%/min |
| Application | | | |
| 3rd | 28.4%/min | 38.7%/min | 0.0%/min |
| Application | | | |
| 4th | 31.5%/min | 36.9%/min | 0.0%/min |
| Application | | | |
| 5th | 17.6%/min | 41.6%/min | 0.0%/min |
| Application | | | |
| Average | 28.3%/min | 36.5%/min | 0.0%/min |

TABLE 4
Results of Wet Feet Test

| | | Example 2 | Comparative |
|---|---|---|---|
| | Example 1 | Nonwoven | Example 1 |
| | Paper Liquid | Fabric Liquid | Plastic |
| | Permeable Panel | Permeable Panel | Grating |
| 1st | 0.00 g | 0.01 g | 0.13 g |
| Application | | | |
| 2nd | 0.01 g | 0.01 g | 0.16 g |
| Application | | | |
| 3rd | 0.00 g | 0.11 g | 0.11 g |
| Application | | | |
| 4th | 0.01 g | 0.03 g | 0.17 g |
| Application | | | |
| 5th | 0.02 g | 0.00 g | 0.11 g |
| Application | | | |
| Average | 0.01 g | 0.03 g | 0.14 g |

With Comparative Example 1, it was proved from Tables 2 and 3 that the plastic grating desirably passes the artificial urine through and that the artificial urine that is not passed through is not absorbed at all. As a result, in the wet feet experiment, a large amount of the artificial urine remaining on the grating adhered to the filter paper. Accordingly, it was proved that, with the conventional animal toilet in which an animal excretes on a plastic grating, wet feet will not be improved.

On the other hand, in Examples 1 and 2 using the liquid permeable panel 3 made of paper or nonwoven fabric and the like that is of a corrugated honeycomb structure, the liquid permeable panel 3 showed superior liquid permeability and a superior water absorbency. Therefore, it was proved that, by using the liquid permeable panel 3 of Examples 1 and 2, most of the artificial urine permeates through the liquid permeable panel 3, a small amount of the artificial urine remaining on the liquid permeable panel 3 is absorbed by the liquid permeable panel 3, and substantially no artificial urine adheres to the filter paper in the wet feet experiment, as shown in Table 4.

1. An animal system toilet comprising:
an excrement container including an excrement storage unit having a space for storing the excrement; and
a liquid permeable panel that is disposable having water absorbency and that is removably disposed so as to cover an upper space of the excrement storage unit.

2. The animal system toilet according to claim 1,
wherein the liquid permeable panel has a plurality of holes that penetrate through the liquid permeable panel in a thickness direction, and
wherein liquid permeates in the thickness direction of the liquid permeable panel through the plurality of holes.

3. The animal system toilet according to claim 1,
wherein the liquid permeable panel includes an organic fiber material, and a hydrophobizing agent or a water repellent agent.

4. The animal system toilet according to claim 1,
wherein the excrement container includes a supporting unit that supports the liquid permeable panel in a state forming a space between the excrement storage unit and the liquid permeable panel.

5. The animal system toilet according to claim 2,
wherein an average area of the plurality of holes is 10 to 100 mm² per hole.

6. The animal system toilet according to claim 1,
wherein the liquid permeable panel has liquid permeability of at least 90%.

7. The animal system toilet according to claim 1,
wherein the liquid permeable panel has water absorbency of 10 to 50%/min.

8. The animal system toilet according to claim 4,
wherein the liquid permeable panel includes a plurality of liquid permeable panel segment bodies that is supported by the supporting unit in a state of being aligned along a planar direction.

9. The animal system toilet according to claim 4,
wherein the supporting unit supports at least a lower face of a pair of side portions of the liquid permeable panel.

10. The animal system toilet according to claim 4,
wherein the supporting unit has a lattice-shaped porous plate and supports substantially an entire area of a lower face of the liquid permeable panel.

11. A disposable liquid permeable panel for an animal system toilet,
wherein the liquid permeable panel has water absorbency, and liquid permeability thereof in a thickness direction is at least 90%

12. The liquid permeable panel according to claim 11, wherein water absorbency of the liquid permeable panel is 10 to 50%/min.

13. The liquid permeable panel according to claim 11, wherein the liquid permeable panel has a plurality of holes that penetrate through the liquid permeable panel in a thickness direction, and
wherein liquid permeates in the thickness direction of the liquid permeable panel through the plurality of holes.
